(19) United States
(12) Patent Application Publication
(10) Pub. No.: US 2010/0069162 A1
(43) Pub. Date: Mar. 18, 2010

(54) BELLOWS FOR A JOINT ARRANGEMENT, COMPRISING A RECEIVER FOR A RETAINER RING

(76) Inventors: Thorsten Scholtz, Rheinbreitbach (DE); Markus Deisinger, Siegberg (DE); Thomas Schmidt, Siegburg (DE)

Correspondence Address: GKN Driveline/TTG, c/o Kristin L. Murphy, 39533 Woodward Avenue, suite 140, Bloomfield Hills, MI, 48304, US

(21) Appl. No.: 12/443,621

(22) PCT Filed: Sep. 29, 2006
(86) PCT No.: PCT/EP2006/009482

§ 371 Date: Oct. 8, 2009

(51) Int. Cl. F16D 3/16; F16J 15/52

(52) U.S. Cl. 464/133; 277/636

(57) ABSTRACT

A bellows for a joint arrangement is disclosed. The bellows comprises an axis, a radius and two ends, a receiver for a retaining ring being formed in the zone adjacent to an end. The receiver is delimited by a plurality of elevations on the end which have a narrow cross-section in the direction of the radius and different flexural properties in opposite directions of the axis.

### CROSS-REFERENCE TO RELATED APPLICATIONS

This application is a National Stage application which claims the benefit of International Application No. PCT/EP2006/009482 filed Sep. 29, 2006 which is hereby incorporated by reference in its entirety.

### BACKGROUND

The present disclosure relates to a bellows for a joint arrangement, comprising an axis, a radius and two ends, a receiver for a retaining ring. The receiver is formed in a region adjacent to an end.

Bellows are used in automobile manufacture to bridge a transition region from a shaft, which transmits a torque, to a joint outer part. Bellows further create a possibility, for example, of arranging lubricant in the joint region, as well as preventing dust or the like penetrating into the joint.

The bellows, which are typically manufactured from a thermoplastic material, often have a conical shape. This conical shape is caused by ends of varying size since a generally smaller opening that is positioned on one end encloses the shaft, while a larger opening on an opposite end serves to receive the joint outer part surrounding the shaft. Between these two ends, the bellows have a plurality of folds in order to be able to compensate for a pivoting and/or a displacement of the shaft relative to the joint arrangement. When used in a motor vehicle, the connection between bellows and shaft or joint outer part must compensate for a plurality of dynamic movements so that a permanent and impervious connection of the bellows is required towards the shaft and the joint outer part.

This connection is typically achieved by a metallic retaining ring which is first pre-mounted loosely on the bellows and, after joining of the bellows to the joint outer part or to the shaft, experiences a reduction in diameter so that the bellows are braced between the retaining ring and the shaft or the joint outer part.

Pre-mounting of the retaining ring is accordingly performed such that the retaining ring is slipped on over the end in an already closed state with an inner diameter which is slightly larger than the outer diameter in the region of the receiver of the bellows. So that the retaining ring does not change its position in an undesirable manner during subsequent transport and/or mounting towards the shaft or the joint outer part, the receiver is designed such that slipping and/or tilting of the retaining ring is prevented, where possible.

Particularly on the end of the bellows, which forms the smaller opening and therefore serves for mounting on the shaft, a material elevation can be provided which adjoins the end and forms a stop edge of the receiver on the opposite side. Such a material elevation only forms a small degree of play to the retaining ring or bellows has to be deformed if the retaining ring is put in place. It should thus be ensured that the retaining ring is not lost during or after pre-mounting.

Putting the retaining ring in place, however, is problematic precisely in relation to series production since a very high accuracy of fit and precisely aligned position of the retaining ring must be assumed before the retaining ring can be mounted on the bellows. It is furthermore possible that, in the event of a deformation of the bellows by the retaining ring, damage occurs to the surface, which damage can subsequently result in greater damage during operation. It should furthermore also be taken into account that, where applicable, in the event of maintenance or servicing on the joint, disassembly of the retaining ring which treats the bellows with care should be achieved.

Therefore, there exists a need for a bellows that produces a reliable and careful pre-mounting of the retaining ring on the bellows and simultaneously enables a long service life of such bellows even when the bellows and retaining rings have to be repeatedly mounted and disassembled.

### BRIEF SUMMARY

A bellows is disclosed herein, having the features of claim 1. Further embodiments of the bellows are indicated in the dependently formulated claims. It should be noted that the features individually listed in the claims can be combined in any desired, technologically expedient manner with one another and exhibit further embodiments of the disclosure. Various embodiments of the disclosure are also explained in the description and the description of the figures.

The bellows for a joint arrangement disclosed herein have an axis, a radius and two ends, a receiver for a retaining ring being formed in a region adjacent to an end. The receiver on the end is delineated by a plurality of material elevations which have a narrow cross-section in the direction of the radius and different flexural properties in opposite direction of the axis.

The material elevations cited here in particular delimit the receiver close to the end with the smaller opening which ultimately serves for connection to the shaft. In one exemplary embodiment, the material elevations which may be formed as injection molded parts with solid material, may also be arranged distributed at equal distances across the circumference of the receiver. In one embodiment, at least 4 material elevations are provided, but an additional number of material elevations may also be formed. The material elevations have a relatively narrow cross-section in the direction of the axis, wherein it is particularly intended that its extension in the direction of the radius is larger than its extension in the direction of the axis. This leads to these material elevations being relatively easily deformable or bendable and thus enabling ease of putting the retaining ring in place during mounting or disassembly.

As a result of the embodiment of the material elevations with different flexural properties, the different functions of the materials elevations can be set in a targeted manner. The functions relate in particular to centering the retaining ring during mounting and to fixing the retaining ring in the mounted state. The different flexural properties of the material elevations are achieved by the combination of material elevations of various designs, the different flexural properties can however also be achieved in the case of individual or all material elevations. For example, individual material elevations or groups of material elevations can thus be formed in a section of the circumference of the bellows with first flexural properties in the direction of the axis different to second flexural characteristics of other material elevations in a different section so that, where applicable, different alignments of the tools for mounting or for disassembly of the retaining ring enable an equally simple mounting and disassembly. The provision of narrow cross-sections with different flexural properties accordingly allows mounting and disassembly of the retaining ring, which treats the bellows with care, wherein the mounted retaining ring can be held equally stable in the receiver.

According to one embodiment of the bellows, at least the material elevations are an injection molded part. An embodiment wherein the entire receiver is likewise embodied as an injection molded part is also disclosed. In this case, the bellows is formed of a thermoplastic.

According to a further development of the bellows, it is proposed that the material elevation in the direction of the axis to the receiver has a smaller bending moment than in the opposite direction. This configuration leads in particular to a lower mounting force being required to put in place the retaining ring towards the receiver than for disassembly of the securing ring. As a result of the narrow cross-section of the material elevation, this disassembly force always, however, remains sufficiently low to perform this procedure where required several times without damaging the bellows.

An embodiment of the bellows is disclosed, wherein the material elevation forms a central plane and the cross-section is formed asymmetrically to this. In other words, the cross-section forms a material accumulation of varying size relative to the central plane. The central plane is defined radially inwards through the center of the width of the material elevation. The material accumulation between the central plane and the receiver is configured in this embodiment to be larger than on the opposite side of the central plane.

It is also advantageous that the material elevation, towards the receiver, forms a stop edge perpendicular to the axis and, towards the adjacent end, an inclined bevel. The bevel is also used to center the closed retaining ring that is mounted. The perpendicular stop edge prevents an unintentional detachment of the retaining ring from the bellows, even in the event of a slight tilted or inclined position of the retaining ring in the receiver.

According to a further embodiment, the material elevation may be embodied with at least one of the following elements: a rib, a recess, a coating, and/or an inclusion. With the help of the ribs which can, for example, be formed distributed in the circumferential direction and extending radially outwards, the different flexural properties can be set in a targeted manner. For the same purpose, recesses (such as, e.g., slots, grooves, notches and the like) and inclusions (such as e.g. rigidifying elements) can be integrated in the material elevation. In order to increase the abrasion resistance and/or influence surface roughness, surfaces of the material elevation can (partially) also be coated.

According to one exemplary embodiment variant, the material elevation has a width in the direction of the axis, a height in the direction of the radius and a length in the direction of the circumference of the bellows, wherein the following relationship applies: the width is configured to be less than the height, which is less than the length. Material elevations in particular are thus indicated which produce a narrow cross-section and simultaneously a large bearing surface in the circumferential direction. Mounting is thus simplified and permanent fixing of the retaining ring during pre-mounting is ensured.

The width of the material elevation in one exemplary embodiment is in a range from about 0.3 to 0.9 mm, the height in the range from about 1.5 to 2.5 mm, and wherein the length is at least 5 mm.

In one embodiment, it is also proposed that the material elevation in the direction of a circumference of the bellows has a different shape to a pitch circle shape. A pitch circle shape has the disadvantage that only very small contact regions between the retaining ring and the material elevations are deformed during assembly, as a result of which the risk of damage is increased. A flatter shape, which differs from the circular shape, prevents such damage and furthermore represents sufficient protection against renewed detachment of the retaining ring.

In one exemplary embodiment, the material elevation in the direction of a circumference of the bellows has two rounded end regions and a central plateau. The central plateau can run in a generally straight line but it is also possible that the plateau substantially follows the radius of the bellows at this point.

The bellows as claimed, may be used in a joint arrangement, at least comprising a joint outer part with a cavity, a joint inner part with a plurality of rollers which are pivotably and rotatably arranged in the cavity, wherein the bellows surround the cavity and the joint inner part. The joint arrangement may be configured as a universal joint or tripod joint. The bellows may be used in a motor vehicle application.

The disclosure is explained in greater detail below with reference to the figures. It should be noted that the figures show embodiment variants of the disclosure, but the disclosures is not restricted to these.

### BRIEF DESCRIPTION OF THE DRAWINGS

FIG. 1 is a cross-sectional view of a joint arrangement with an embodiment of a bellows;

FIG. 2 is a cross-sectional view of a joint arrangement;

FIG. 3 schematically illustrates a top view of an embodiment variant of a material elevation;

FIG. 4 schematically illustrates a further embodiment variant of a material elevation;

FIG. 5 schematically illustrates a further embodiment variant of a bellows with a material elevation in cross-section;

FIG. 6 schematically illustrates a further embodiment variant of a material elevation;

FIG. 7 schematically illustrates a cross-section through the material elevation from FIG. 6,

FIG. 8 schematically illustrates yet another exemplary embodiment of a material elevation in cross-section; and

FIG. 9 schematically illustrates a motor vehicle with several bellows.

### DETAILED DESCRIPTION

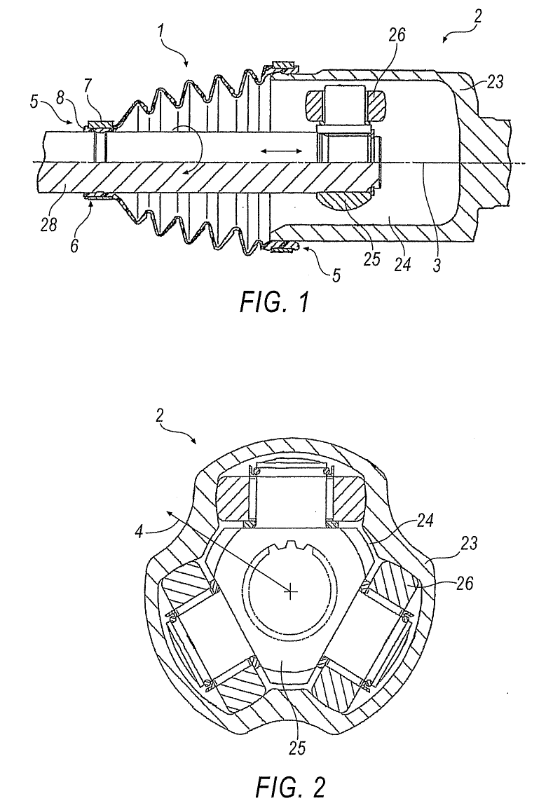

FIG. 1 schematically illustrates in partial cross-section, a possible embodiment variant of a joint arrangement 2 with a bellows 1 which collectively span a region from a shaft 28 to a joint outer part 23. In this case, bellows 1 is embodied on both ends 5 with a receiver 6 in which a retaining ring 7 is positioned. The receiver 6 ensures connection of the bellows 1 to shaft 28 or to joint outer part 23. It is also illustrated here that material elevations 8 are provided at end 5 that serves to join to shaft 28, which therefore forms the smaller opening cross-section.

Joint arrangement 2 is used to transmit a torque, wherein shaft 28 rotates. This rotational movement is transmitted via joint inner part 25 fastened on shaft 28. There, a plurality of rollers 26 which adjoin in joint outer part 23 are provided in the direction of radius 4 (cf. also FIG. 2). In order to ensure a bending angle between shaft 28 and joint outer part 23 and/or to ensure an axial relative movement between shaft 28 and joint outer part 23, rollers 26 roll in corresponding guide paths of joint outer part 23, wherein the rotation of shaft 28 can be simultaneously transmitted. Bellows 1 encompass joint outer part 23 and shaft 28 and thus also in particular cover cavity 24 of the bell- or tulip-like joint outer part 23. Lubricant can, for example, thus be positioned in this cavity 24, wherein contamination by dirt is simultaneously reliably prevented.

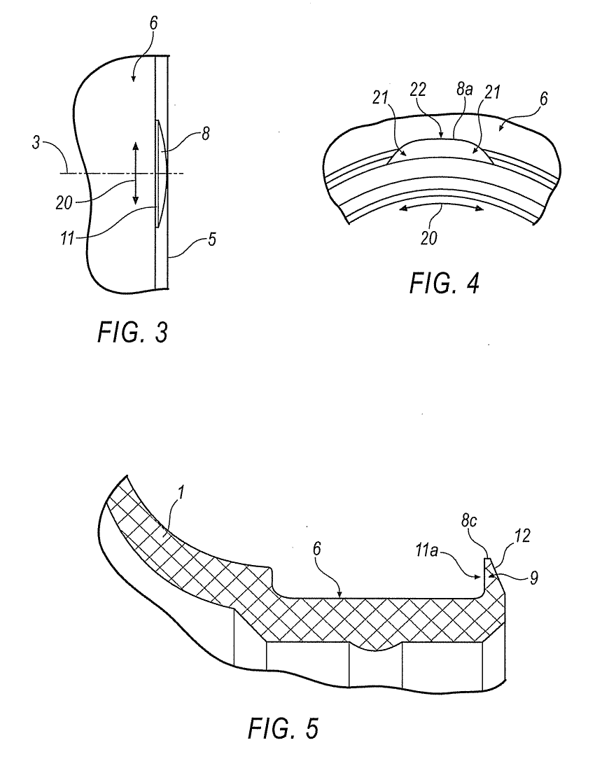

FIG. 3 illustrates in a top view an embodiment variant of a material elevation 8 which extends in the direction of circumference 20 of bellows 1 and partially delimits receiver 6 towards end 5. In the exemplary embodiment illustrated, material elevation 8 has a generally straight stop edge 11 which runs parallel to receiver 6. Opposite stop edge 11, the material elevation 8 has a curved outer region so that material elevation 8 has different flexural properties in the direction of the axis of the bellows.

An embodiment variant of material elevation 8a is apparent from FIG. 4 which has a different shape in the direction of circumference 20 from a pitch circle shape. The shape of material elevation 8a can be defined by two (possibly mirror-symmetrically formed) end regions 21 and a central plateau 22.

FIG. 5 illustrates a detail of bellows 1 in cross-section, wherein the delimitation of receiver 6 at the end 5 by a material elevation 8c is apparent. Material elevation 8c, which is formed here as an injection molded part with a narrow cross-section 9, in turn has a generally perpendicular stop edge 11a, wherein an inclined bevel 12 is formed towards end 5. The retaining ring is thus centered and guided during pre-mounting, wherein material elevation 8c can be easily deformed towards receiver 6 (i.e. is flexible). On the other hand, a deformation in the opposite direction expends significantly more force (harder flexural properties).

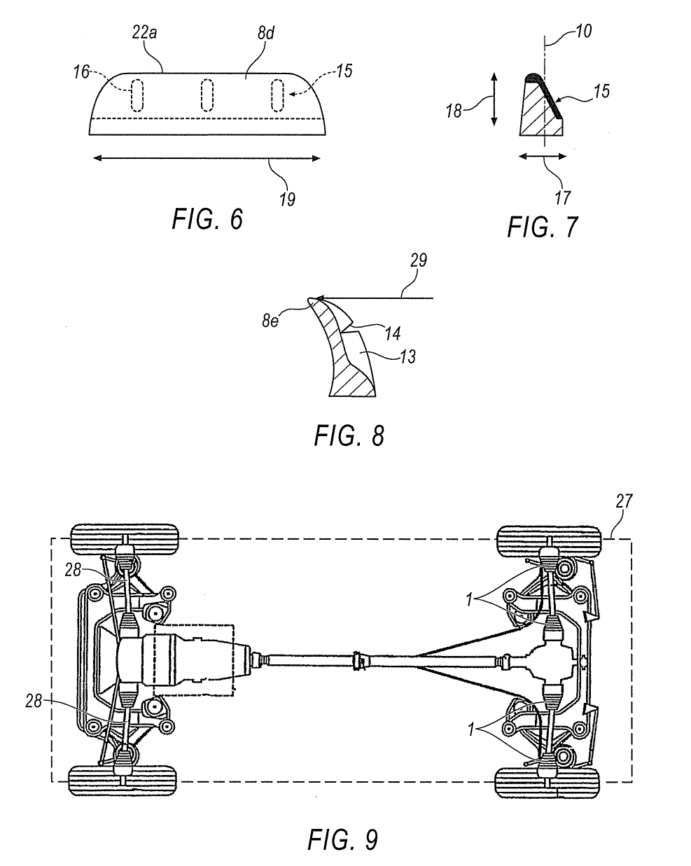

FIGS. 6 and 7 illustrate a further embodiment variant of a material elevation 8d. It is apparent from FIG. 6 that material elevation 8d is in turn formed with a generally straight plateau 22a and generally extends in the direction of a circumference 20 over a predefined length 19. Various inclusions 16 and a large-surface coating 15 are furthermore indicated in FIG. 6. A cross-section through material elevation 8d shown in FIG. 6 is represented in FIG. 7. Material elevation 8d has a generally narrow cross-section, wherein a width 17 is embodied smaller in the direction of the axis than a height 18 in the direction of the radius of the bellows 1. The different flexural properties are produced in that, relative to central plane 10, the material is distributed asymmetrically in cross-section. For the purpose of illustration, partial coating 15 of the surface of material elevation 8d is also illustrated once again.

FIG. 8 shows a further embodiment variant of material elevation 8e in the partially deformed state which was caused by a force 29 which, for example, occurs during mounting of the retaining ring (shown in FIG. 1). In order to enable a particularly flexible bending in the direction of receiver 6, material elevation 8e is formed with a plurality of ribs 13 which also have slot-like recesses 14 which fold down in the indicated direction in the event of deformation. A significantly higher force is required for a deformation of material elevation 8e in the opposite direction of force 29.

A motor vehicle 27 is schematically represented in FIG. 9 as an exemplary field of application of the disclosure. The transmission of force from the engine to the individual wheels is performed in this case via a plurality of shafts 28 which are embodied with different joint arrangements which at least partially have a bellows 1 of the type illustrated herein.

1. A bellows for a joint arrangement comprising: an axis, a radius and two ends, a receiver for a retaining ring being formed in the region adjacent to at least one of the ends, the receiver being delimited by a plurality of material elevations on at least one of the ends, wherein the material elevations have a narrow cross-section in the direction of the radius and different flexural properties in opposite direction of the axis.

2. The bellows as claimed in claim 1, wherein at least the material elevations are formed by injection molding.

3. The bellows as claimed in claim 1, wherein the material elevations in the direction of the axis to the receiver has a smaller bending moment than in the opposite direction.

4. The bellows as claimed in claim 1, wherein the material elevations form a central plane and the cross-section is formed asymmetrically to this the central plane.

5. The bellows as claimed in claim 1, wherein at least one of the material elevations, towards the receiver, forms a stop edge that is generally perpendicular to the axis and, towards the adjacent end, includes an inclined bevel.

6. The bellows as claimed claim 1, wherein the material elevation is embodied with at least one of the following structure: a rib, a recess, a coating, and an inclusion.

7. The bellows as claimed in claim 1, wherein at least one of the material elevations has a width in the direction of the axis, a height in the direction of the radius and a length in the direction of a circumference of the bellows, and the following relationship applies:
Width<Height<Length.

8. The bellows as claimed in claim 1, wherein at least one of the material elevations in the direction of a circumference of the bellows has a different shape to a pitch circle shape.

9. The bellows as claimed in claim 8, wherein the material elevation in the direction of the circumference of the bellows has two rounded end regions and a central plateau.

10. A joint arrangement at least comprising a joint outer part with a cavity, a joint inner part with a plurality of rollers which are pivotably and rotatably arranged in the cavity and a bellows that surrounds the cavity and the joint inner part;
wherein the bellows comprises an axis, a radius and two ends, a receiver for a retaining ring being formed in the region adjacent to at least one of the ends, the receiver being delimited by a plurality of material elevations on at least one of the ends, wherein the material elevations are defined by a narrow cross-section in the direction of the radius and different flexural properties in opposite direction of the axis.

11. (canceled)

12. The joint arrangement of claim 10, wherein the joint arrangement is arranged in a motor vehicle.
